(19) United States
(12) Patent Application Publication
(10) Pub. No.: US 2016/0377701 A1
(43) Pub. Date: Dec. 29, 2016

(54) SYSTEM AND METHOD FOR DETECTING MOUNTING ANGLE OF BLIND SPOT DETECTION SENSOR

(71) Applicant: Hyundai Motor Company, Seoul (KR)

(72) Inventors: Jin Seok Kim, Yongin (KR); Haseung Seong, Daejeon (KR); Il Hwan Lee, Seoul (KR)

(21) Appl. No.: 14/962,159

(22) Filed: Dec. 8, 2015

(30) Foreign Application Priority Data
Jun. 26, 2015 (KR) 10-2015-0091368

(51) Int. Cl. G01S 7/40; G01S 13/93

(52) U.S. Cl. CPC G01S 7/4026; G01S 13/931; B60Q 9/008

(57) ABSTRACT

A mounting angle detection system of a Blind Spot Detection (BSD) sensor includes: the BSD sensor that is mounted at a predetermined location of a vehicle so as to detect a peripheral object; a displacement sensor that is fixedly disposed outside of the vehicle so as to detect a location of the vehicle; a Doppler generator that generates a radio wave of a wavelength in which the BSD sensor can detect; a moving unit that moves the Doppler generator to a detection area in which the BSD sensor can detect; and a control unit that calculates a deviation between a detection location and a reference location of the vehicle and that controls the moving unit so as to correct a location of the Doppler generator according to the deviation.

### CROSS-REFERENCE TO RELATED APPLICATION

This application claims under 35 U.S.C. §119(a) the benefit of Korean Patent Application No. 10-2015-0091368 filed in the Korean Intellectual Property Office on Jun. 26, 2015, the entire contents of which are incorporated herein by reference.

### BACKGROUND

(a) Field of the Invention

The present invention relates to a mounting angle detection system of a Blind Spot Detection (B SD) sensor that enables accurate detection of a blind spot by detecting a mounting angle of the BSD sensor provided in a BSD device that is disposed at a rear side of a vehicle.

(b) Description of the Related Art

A BSD device has been incorporated into a vehicle as a safety device, and the BSD device provides, to a driver, location information about an approaching vehicle or object in order to prevent an accident.

Further, the BSD device includes a sensor that detects an approaching object and a display unit that displays the approaching object, and may detect an area that cannot be seen with an existing rearview mirror. Further, the BSD device may be classified according to a detection sensor type and a warning display method.

The detection sensor type includes one of radar, an ultrasonic wave, and a camera, and the radar type detection sensor is widely applied. Further, the warning display method includes a sound alarm method (through sound), and a visual sense alarm method that visually expresses in a rearview mirror and an A-filler.

During vehicle assembly, a mounting angle of a BSD sensor is measured, and when such a mounting angle has a large deviation from a reference angle, reassembly is performed.

In this way, in order to detect a mounting angle of a BSD sensor, a Doppler generator is disposed outside of the vehicle, and the BSD sensor detects a radio wave that is generated in the Doppler generator, such that a mounting angle of the BSD sensor may be detected according to a detected direction and a location of the Doppler generator.

When the vehicle enters a BSD mounting angle system, if the vehicle is not disposed at a predetermined reference location, a mounting angle of the BSD sensor cannot be more accurately detected.

The above information disclosed in this Background section is only for enhancement of understanding of the background of the invention and therefore it may contain information that does not form the prior art that is already known in this country to a person of ordinary skill in the art.

### SUMMARY

The present invention provides a system and method for detecting a mounting angle of a BSD sensor having advantages of being capable of more accurately detecting a mounting angle of the BSD sensor that is disposed in a vehicle regardless of a stop location of the vehicle and being capable of accurately correcting the mounting angle.

An exemplary embodiment of the present invention provides a mounting angle detection system of a Blind Spot Detection (BSD) sensor including: the BSD sensor that is mounted at a predetermined location of a vehicle so as to detect a peripheral object; a displacement sensor that is fixedly disposed outside of the vehicle so as to detect a location of the vehicle; a Doppler generator configured to generate a radio wave of a wavelength in which the BSD sensor can detect; a moving unit that moves the Doppler generator to a detection area in which the BSD sensor can detect; and a control unit that calculates a deviation between a detection location and a reference location of the vehicle and that controls the moving unit so as to correct a location of the Doppler generator according to the deviation.

The control unit may calculate a mounting angle of the BSD sensor according to a location of the Doppler generator that is detected by the BSD sensor.

The BSD sensor may be disposed at both sides of a rear side of the vehicle.

The moving unit may be a multi-axis robot.

The control unit may compare a mounting angle and a reference mounting angle of the BSD sensor, generate a fail signal, if a difference value between the mounting angle and the reference mounting angle exceeds a predetermined value, and generate a pass signal, if a difference value between the mounting angle and the reference mounting angle is a predetermined value or less.

The displacement sensor may detect a location of the vehicle using radar.

Another embodiment of the present invention provides a method of detecting a mounting angle of a Blind Spot Detection (BSD) sensor including: detecting a detection location of a stopped vehicle through a displacement sensor; calculating a deviation between the detection location and a reference location; and correcting a location of a Doppler generator that is detected by the BSD sensor according to the deviation.

The method may further include determining a detection area that is detected by the BSD sensor according to operation of the Doppler generator and calculating a mounting angle of the BSD sensor according to the detection area.

The method may further include generating, by the Doppler generator, a radio wave of a wavelength in which the BSD sensor can detect.

The method may further include: comparing a mounting angle and a reference mounting angle of the BSD sensor; generating, if a difference value between the mounting angle and the reference mounting angle exceeds a predetermined value, a fail signal; and generating, if a difference value between the mounting angle and the reference mounting angle is a predetermined or less, a pass signal.

According to the present invention for achieving such an object, by more accurately detecting a mounting angle of a BSD sensor that is provided in a BSD device and by enabling to reassemble the BSD sensor, driving stability and marketability of a vehicle can be simultaneously improved.

### BRIEF DESCRIPTION OF THE DRAWINGS

FIG. 1 is a schematic diagram of a mounting angle detection system of a BSD sensor according to an exemplary embodiment of the present invention.

FIG. 2 is a flowchart illustrating a method of detecting a mounting angle of a BSD sensor according to an exemplary embodiment of the present invention.

FIG. 3 is a schematic diagram of a mounting angle detection system of a BSD sensor according to an exemplary embodiment of the present invention.

FIG. 4 is a schematic diagram illustrating a method of detecting a mounting angle of a BSD sensor according to an exemplary embodiment of the present invention.

### DETAILED DESCRIPTION OF THE EMBODIMENTS

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present invention may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

An exemplary embodiment of the present invention will hereinafter be described in detail with reference to the accompanying drawings.

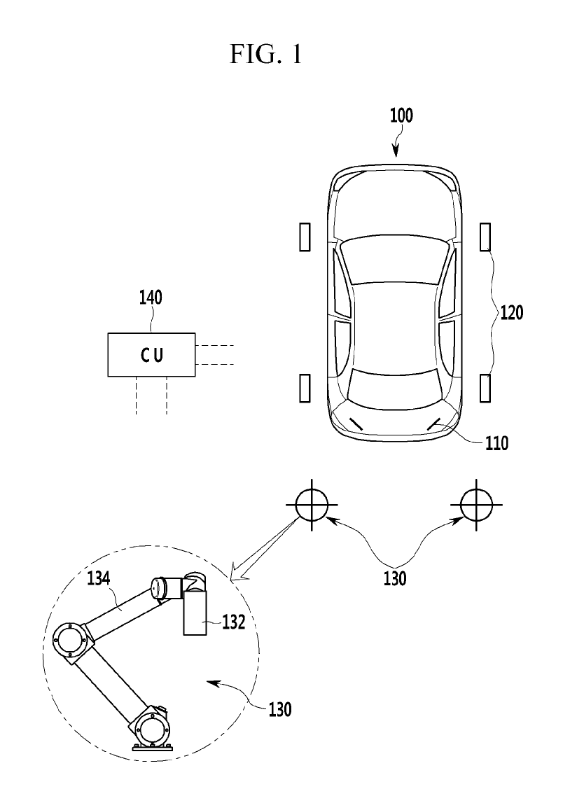

FIG. 1 is a schematic diagram of a mounting angle detection system of a Blind Spot Detection (BSD) sensor according to an exemplary embodiment of the present invention.

Referring to FIG. 1, the mounting angle detection system includes a vehicle 100, a displacement sensor 120, a BSD sensor 110, a Doppler generation apparatus 130, and a control unit 140, and the Doppler generation apparatus 130 includes a Doppler generator 132 and a moving unit 134.

The BSD sensor 110 is disposed at both sides of a rear side of the vehicle 100 and is disposed to be inclined at an angle that is set to detect an object approaching both sides of the rear side of the vehicle 100. As used herein, the term “both sides” refers to two locations on the rear side of the vehicle, and the BSD sensor 110 can be disposed, e.g., at the two locations separated by a predetermined distance on the rear side of the vehicle.

The displacement sensors 120 are disposed with two pieces at each of both sides of the stopped vehicle 100 to detect a stop location of the vehicle 100. Each displacement sensor 120 may detect a location signal of the vehicle 100 using radar.

The Doppler generation apparatus 130 is disposed at the rear side of the vehicle 100 to correspond to the BSD sensor 110, and the Doppler generation apparatus 130 includes a Doppler generator 132 that generates a radio wave having a wavelength band in which the BSD sensor 110 can detect and a moving unit 134 that can adjust a location of the Doppler generator 132.

A 6-axis adjustment type as a multi-axis robot type may be applied to the moving unit 134, and in an end portion of an arm of the multi-axis robot, the Doppler generator 132 may be disposed.

The control unit 140 may detect an actual location of the vehicle 100 through the displacement sensor 120 and compare a reference location and the actual location, thereby calculating a location deviation between the actual location and the reference location.

The control unit 140 controls the moving unit 134 according to the location deviation, thereby correcting a location of the Doppler generator 132, and the Doppler generator 132 may generate the radio wave having the wavelength band in which the BSD sensor 110 can detect at a corrected location.

Here, a radio wave that is output from the Doppler generator 132 may be a microwave, an ultrasonic wave, or other similar waves.

The BSD sensor 110 may detect a location of the radio wave that is generated in the Doppler generator 132 and calculate a mounting angle of the BSD sensor 110 through a relationship between the detected location and an actual location of the Doppler generator 132.

The control unit 140 may be implemented with at least one microprocessor operating by a predetermined program, and the predetermined program may include a series of instructions for performing a method according to an exemplary embodiment of the present invention to be described later.

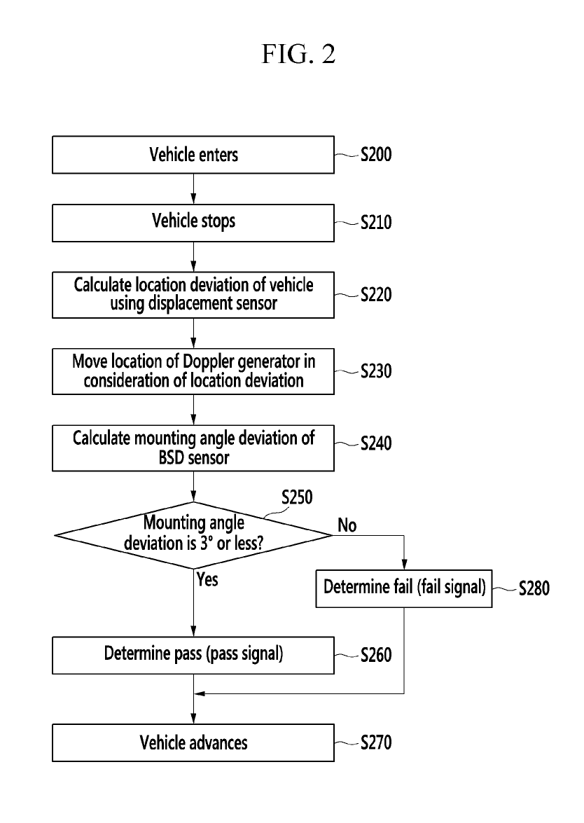

FIG. 2 is a flowchart illustrating a method of detecting a mounting angle of a BSD sensor according to an exemplary embodiment of the present invention.

Referring to FIG. 2, the vehicle 100 enters at a test location (S200), and the vehicle 100 stops at a predetermined location of the test location (S210).

The displacement sensor 120 detects an actual location of the stopped vehicle 100 by the control unit 140, and the control unit 140 calculates a location deviation between the actual location and a reference location (S220).

The control unit 140 controls the moving unit 134 using the calculated location deviation to correct a location of the Doppler generator 132 (S230).

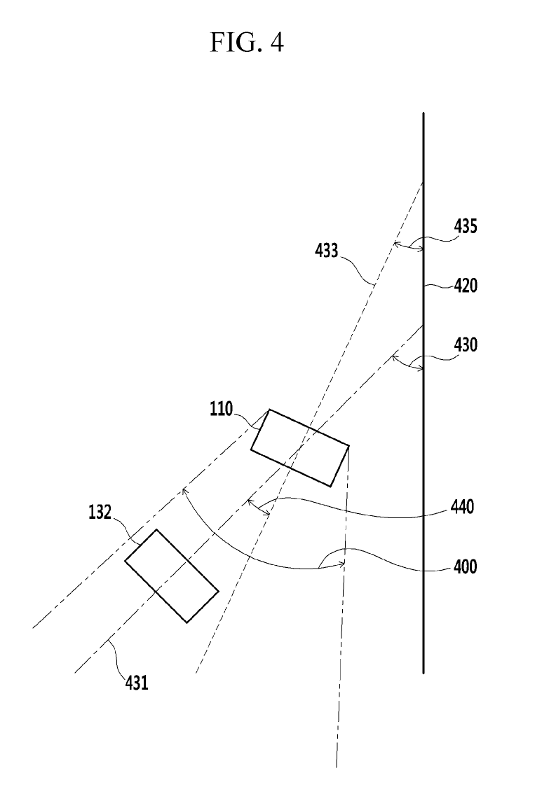

The control unit 140 calculates a mounting angle deviation (see reference number 440 of FIG. 4) of the BSD sensor 110 (S240). A mounting angle deviation of the BSD sensor 110 may be calculated from a radio wave central axis (see reference number 431 of FIG. 4) of a radio wave that is generated in the Doppler generator 132 and a measurement reference axis (see reference number 433 of FIG. 4) of the BSD sensor 110 that detects the radio wave that is generated in the Doppler generator 132.

For example, when the measurement reference axis 433 of the BSD sensor 110 and the radio wave central axis 431 of the Doppler generator 132 correspond, measurement sensitivity of the BSD sensor 110 increases to the largest. However, if the measurement reference axis 433 and the radio wave central axis 431 do not correspond, measurement sensitivity of the BSD sensor 110 gradually decreases. The control unit 140 may calculate a mounting angle deviation (see reference number 440 of FIG. 4) of the BSD sensor 110 through such a characteristic.

The control unit 140 determines whether a mounting angle deviation of the BSD sensor 110 is a predetermined value (e.g., 3°) or less (S250).

If the mounting angle deviation 440 of the BSD sensor 100 is a predetermined value or less, the control unit 140 generates a pass signal (S260), and if the mounting angle deviation 440 of the BSD sensor 100 is larger than a predetermined value, the control unit 140 generates a fail signal (S280), and the vehicle 100 advances (S270).

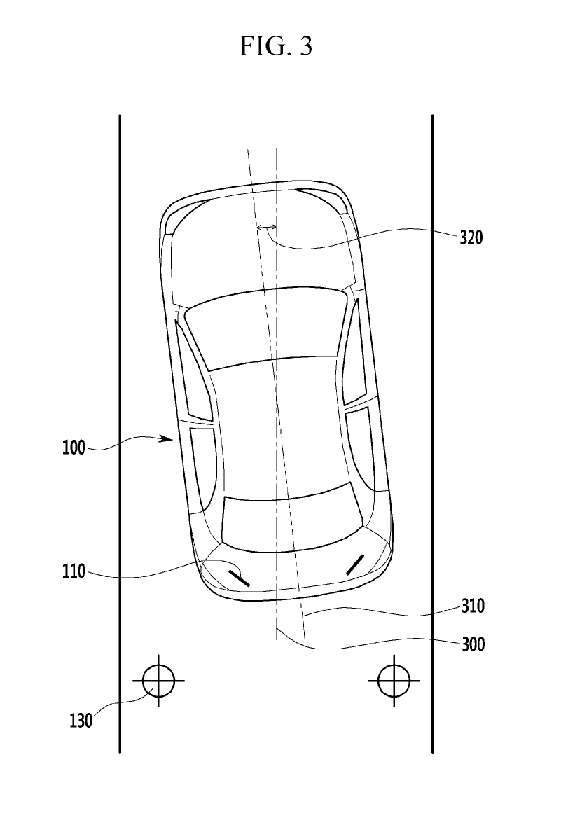

FIG. 3 is a schematic diagram of a mounting angle detection system of a BSD sensor according to an exemplary embodiment of the present invention.

Referring to FIG. 3, a deviation occurs between a length direction central axis 310 and a reference line 300 of a vehicle, and a test area direction of the BSD sensor 110 is changed by the deviation. Therefore, it is difficult to accurately detect a mounting angle of the BSD sensor 110 by the Doppler generator 132.

As described above, in an exemplary embodiment of the present invention, by correcting a location of the Doppler generator 132 according to the deviation, a mounting angle of the BSD sensor 110 can be more accurately obtained.

FIG. 4 is a schematic diagram illustrating a method of detecting a mounting angle of a BSD sensor according to an exemplary embodiment of the present invention.

Referring to FIG. 4, an actual central axis 420 of the vehicle is formed. The actual central axis 420 may be calculated by an actual location of the vehicle 100 that is detected by the displacement sensor 120.

At a predetermined location of the vehicle 100, the BSD sensor 110 is disposed. A location of the Doppler generator 132 is set to correspond to the actual central axis 420, and the BSD sensor 110 detects a radio wave that is generated in the Doppler generator 132.

The BSD sensor 110 has a predetermined detection area 400, and the Doppler generator 132 is located within the detection area 400.

The detection area 400 is an area in which the BSD sensor 110 can detect the radio wave and may be an angle range that is set by a measurement reference axis 433 of the BSD sensor 110.

As shown in FIG. 4, a reference mounting angle 430 is formed between a radio wave central axis 431, which is the center of the radio wave that is generated in the Doppler generator 132 and the vehicle central axis 420. The reference mounting angle 430 is an angle in which a location of the Doppler generator 132 is corrected by the control unit 140. The reference mounting angle 430 is an angle (location) in which the BSD sensor 110 is to be installed in the vehicle based on the actual central axis 420.

A BSD mounting angle 435 is formed between the measurement reference axis 433 in which the BSD sensor 110 detects a radio wave and the vehicle central axis 420. The BSD mounting angle 435 is an angle in which the BSD sensor 110 is presently installed in the vehicle.

A mounting angle deviation 440 is formed between the radio wave central axis 431 of the Doppler generator 132 and the measurement reference axis 433 of the BSD sensor 110. The mounting angle deviation 440 is an error in which the BSD sensor is presently installed in the vehicle 100.

In an exemplary embodiment of the present invention, if the mounting angle deviation 440 is larger than a predetermined value (e.g., 3°), the control unit 140 determines that a mounting location of the BSD sensor 110 is abnormal and generates a fail signal, thereby correcting a mounting angle of the BSD sensor 110. In this case, an operator adjusts a mounting location of the BSD sensor 110, thereby enabling the BSD mounting angle 435 to correspond with the reference mounting angle 430.

If the mounting angle deviation 440 is a predetermined value or less, the control unit 140 determines that a mounting location of the BSD sensor 110 is normal and generates a pass signal, thereby completing mounting of the BSD sensor 110.

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

What is claimed is:

1. A mounting angle detection system of a Blind Spot Detection (BSD) sensor, the mounting angle detection system comprising:
the BSD sensor that is mounted at a predetermined location of a vehicle so as to detect a peripheral object;
a displacement sensor that is disposed outside of the vehicle so as to detect a location of the vehicle;
a Doppler generator configured to generate a radio wave of a wavelength in which the BSD sensor can detect;
a moving unit that moves the Doppler generator to a detection area in which the BSD sensor can detect; and
a control unit that calculates a deviation between an actual location and a reference location of the vehicle and that controls the moving unit so as to correct a location of the Doppler generator according to the deviation.

2. The mounting angle detection system of claim 1, wherein the control unit calculates a mounting angle deviation of the BSD sensor from a radio wave central axis of the radio wave that is generated in the Doppler generator and a measurement reference axis of the BSD sensor.

3. The mounting angle detection system of claim 2, wherein the control unit compares the mounting angle deviation and a predetermined value of the BSD sensor,
generates a fail signal, if the mounting angle deviation exceeds the predetermined value, and
generates a pass signal, if the mounting angle deviation is the predetermined value or less.

4. The mounting angle detection system of claim 1, wherein the BSD sensor is disposed at both sides of a rear side of the vehicle.

5. The mounting angle detection system of claim 1, wherein the moving unit is a multi-axis robot.

6. The mounting angle detection system of claim 1, wherein the displacement sensor detects a location of the vehicle using radar.

7. A method of detecting a mounting angle of a Blind Spot Detection (BSD) sensor, the method comprising the steps of:
detecting an actual location of a stopped vehicle through a displacement sensor;
calculating a deviation between the actual location and a reference location; and
correcting a location of a Doppler generator that is detected by the BSD sensor according to the deviation.

8. The method of claim 7, further comprising the step of:
calculating a mounting angle deviation of the BSD sensor from a radio wave central axis of a radio wave that is generated in the Doppler generator and a measurement reference axis of the BSD sensor.

9. The method of claim 7, further comprising the steps of:
comparing a mounting angle deviation and a predetermined value of the BSD sensor;
generating, if the mounting angle deviation exceeds the predetermined value, a fail signal; and
generating, if the mounting angle deviation is the predetermined value or less, a pass signal.
